(19) United States
(12) Patent Application Publication
(10) Pub. No.: US 2009/0067494 A1
(43) Pub. Date: Mar. 12, 2009

(54) Enhancing the coding of video by post multi-modal coding

(75) Inventor: Iraj Sodagar, La Jolla, CA (US)

Correspondence Address: HAVERSTOCK & OWENS LLP, 162 N WOLFE ROAD, SUNNYVALE, CA, 94086, US

(73) Assignees: SONY CORPORATION, a Japanese corporation; SONY ELECTRONICS INC., a corporation of the State of Delaware

(21) Appl. No.: 12/150,204

(22) Filed: Apr. 25, 2008

Related U.S. Application Data
(60) Provisional application No. 60/967,952, filed on Sep. 6, 2007.

(51) Int. Cl. H04N 7/26

(52) U.S. Cl. 375/240.08; 375/240.01; 375/E07.189

(57) ABSTRACT

Post multi-modal coding overcomes the shortcomings of video encoders which fail to meet an expected quality standard while encoding some portions of a video. The deficient encoding is typically due to the type of video content or the encoding technique. A method to improve the quality of the deficient portions, identifies macroblocks that are encoded at a deficient quality. Then, the identified macroblocks are encoded with another suitable encoding technique so that the desired quality is met. The improved macroblocks are then inserted into the original bit-stream, replacing the lower quality sections.

### RELATED APPLICATION(S)

This application claims priority under 35 U.S.C. §119(e) of the co-pending, co-owned U.S. Provisional Patent Application, Ser. No. 60/967,952, filed Sep. 6, 2007, and entitled “ENHANCING THE CODING OF VIDEO BY POST MULTI-MODAL CODING,” which is hereby incorporated by reference.

### FIELD OF THE INVENTION

The present invention relates to the field of video encoding. More specifically, the present invention relates to enhancing the coding of video by using a variety of types of encoding.

### BACKGROUND OF THE INVENTION

A video sequence consists of a number of pictures, usually called frames. Subsequent frames are very similar, thus containing a lot of redundancy from one frame to the next. Before being efficiently transmitted over a channel or stored in memory, video data is compressed to conserve both bandwidth and memory. The goal is to remove the redundancy to gain better compression ratios. A first video compression approach is to subtract a reference frame from a given frame to generate a relative difference. A compressed frame contains less information than the reference frame. The relative difference can be encoded at a lower bit-rate with the same quality. The decoder reconstructs the original frame by adding the relative difference to the reference frame.

A more sophisticated approach is to approximate the motion of the whole scene and the objects of a video sequence. The motion is described by parameters that are encoded in the bit-stream. Pixels of the predicted frame are approximated by appropriately translated pixels of the reference frame. This approach provides an improved predictive ability than a simple subtraction. However, the bit-rate occupied by the parameters of the motion model must not become too large.

In general, video compression is performed according to many standards, including one or more standards for audio and video compression from the Moving Picture Experts Group (MPEG), such as MPEG-1, MPEG-2, and MPEG-4. Additional enhancements have been made as part of the MPEG-4 part 10 standard, also referred to as H.264, or AVC (Advanced Video Coding). Under the MPEG standards, video data is first encoded (e.g. compressed) and then stored in an encoder buffer on an encoder side of a video system. Later, the encoded data is transmitted to a decoder side of the video system, where it is stored in a decoder buffer, before being decoded so that the corresponding pictures can be viewed.

The intent of the H.264/AVC project was to develop a standard capable of providing good video quality at bit rates that are substantially lower than what previous standards would need (e.g. MPEG-2, H.263, or MPEG-4 Part 2). Furthermore, it was desired to make these improvements without such a large increase in complexity that the design is impractical to implement. An additional goal was to make these changes in a flexible way that would allow the standard to be applied to a wide variety of applications such that it could be used for both low and high bit rates and low and high resolution video. Another objective was that it would work well on a very wide variety of networks and systems.

H.264/AVC/MPEG-4 Part 10 contains many new features that allow it to compress video much more effectively than older standards and to provide more flexibility for application to a wide variety of network environments. Some key features include multi-picture motion compensation using previously-encoded pictures as references, variable block-size motion compensation (VBSMC) with block sizes as large as 16×16 and as small as 4×4, six-tap filtering for derivation of half-pel luma sample predictions, macroblock pair structure, quarter-pixel precision for motion compensation, weighted prediction, an in-loop deblocking filter, an exact-match integer 4×4 spatial block transform, a secondary Hadamard transform performed on “DC” coefficients of the primary spatial transform wherein the Hadamard transform is similar to a fast Fourier transform, spatial prediction from the edges of neighboring blocks for “intra” coding, context-adaptive binary arithmetic coding (CABAC), context-adaptive variable-length coding (CAVLC), a simple and highly-structured variable length coding (VLC) technique for many of the syntax elements not coded by CABAC or CAVLC, referred to as Exponential-Golomb coding, a network abstraction layer (NAL) definition, switching slices, flexible macroblock ordering, redundant slices (RS), supplemental enhancement information (SEI) and video usability information (VUI), auxiliary pictures, frame numbering and picture order count. These techniques, and several others, allow H.264 to perform significantly better than prior standards, and under more circumstances and in more environments. H.264 usually performs better than MPEG-2 video by obtaining the same quality at half of the bit rate or even less.

MPEG is used for the generic coding of moving pictures and associated audio and creates a compressed video bit-stream made up of a series of three types of encoded data frames. The three types of data frames are an intra frame (called an I-frame or I-picture), a bi-directional predicated frame (called a B-frame or B-picture), and a forward predicted frame (called a P-frame or P-picture). These three types of frames can be arranged in a specified order called the GOP (Group Of Pictures) structure. I-frames contain all the information needed to reconstruct a picture. The I-frame is encoded as a normal image without motion compensation. On the other hand, P-frames use information from previous frames and B-frames use information from previous frames, a subsequent frame, or both to reconstruct a picture. Specifically, P-frames are predicted from a preceding I-frame or the immediately preceding P-frame.

Frames can also be predicted from the immediate subsequent frame. In order for the subsequent frame to be utilized in this way, the subsequent frame must be encoded before the predicted frame. Thus, the encoding order does not necessarily match the real frame order. Such frames are usually predicted from two directions, for example from the I- or P-frames that immediately precede or the P-frame that immediately follows the predicted frame. These bidirectionally predicted frames are called B-frames.

There are many possible GOP structures. A common GOP structure is 15 frames long, and has the sequence I_BB_P_BB_P_BB_P_BB_P_BB_. A similar 12-frame sequence is also common. I-frames encode for spatial redundancy, P and B-frames for both temporal redundancy and spatial redundancy. Because adjacent frames in a video stream are often well-correlated, P-frames and B-frames are only a small percentage of the size of I-frames. However, there is a trade-off between the size to which a frame can be compressed versus the processing time and resources required to encode such a compressed frame. The ratio of I, P and B-frames in the GOP structure is determined by the nature of the video stream and the bandwidth constraints on the output stream, although encoding time may also be an issue. This is particularly true in live transmission and in real-time environments with limited computing resources, as a stream containing many B-frames can take much longer to encode than an I-frame-only file.

B-frames and P-frames require fewer bits to store picture data, generally containing difference bits for the difference between the current frame and a previous frame, subsequent frame, or both. B-frames and P-frames are thus used to reduce redundancy information contained across frames. In operation, a decoder receives an encoded B-frame or encoded P-frame and uses a previous or subsequent frame to reconstruct the original frame. This process is much easier and produces smoother scene transitions when sequential frames are substantially similar, since the difference in the frames is small.

Each video image is separated into one luminance (Y) and two chrominance channels (also called color difference signals Cb and Cr). Blocks of the luminance and chrominance arrays are organized into “macroblocks,” which are the basic unit of coding within a frame.

In the case of I-frames, the actual image data is passed through an encoding process. However, P-frames and B-frames are first subjected to a process of “motion compensation.” Motion compensation is a way of describing the difference between consecutive frames in terms of where each macroblock of the former frame has moved. Such a technique is often employed to reduce temporal redundancy of a video sequence for video compression. Each macroblock in the P-frames or B-frame is associated with an area in the previous or next image that it is well-correlated, as selected by the encoder using a “motion vector.” The motion vector that maps the macroblock to its correlated area is encoded, and then the difference between the two areas is passed through the encoding process.

Conventional video codecs use motion compensated prediction to efficiently encode a raw input video stream. The macroblock in the current frame is predicted from a displaced macroblock in the previous frame. The difference between the original macroblock and its prediction is compressed and transmitted along with the displacement (motion) vectors. This technique is referred to as inter-coding, which is the approach used in the MPEG standards.

One of the most time-consuming components within the encoding process is motion estimation. Motion estimation is utilized to reduce the bit rate of video signals by implementing motion compensated prediction in combination with transform coding of the prediction error. Motion estimation-related aliasing is not able to be avoided by using inter-pixel motion estimation, and the aliasing deteriorates the prediction efficiency. In order to solve the deterioration problem, half-pixel interpolation and quarter-pixel interpolation are adapted for reducing the impact of aliasing. To estimate a motion vector with quarter-pixel accuracy, a three step search is generally used. In the first step, motion estimation is applied within a specified search range to each integer pixel to find the best match. Then, in the second step, eight half-pixel points around the selected integer-pixel motion vector are examined to find the best half-pixel matching point. Finally, in the third step, eight quarter-pixel points around the selected half-pixel motion vector are examined, and the best matching point is selected as the final motion vector. Considering the complexity of the motion estimation, the integer-pixel motion estimation takes a major portion of motion estimation if a full-search is used for integer-pixel motion estimation. However, if a fast integer motion estimation algorithm is utilized, an integer-pixel motion vector is able to be found by examining less than ten search points. As a consequence, the computation complexity of searching the half-pixel motion vector and quarter-pixel motion vector becomes dominant.

Video coders have been improved in recent years, but one of the common drawbacks of the coders is the fact that they tend to fail to encode some parts of the content depending on the nature of the content and the employed method of encoding. Previous approaches to improve encoding quality are much more complex. The methods of improving encoding involve video classification and segmentation techniques which are complex and do not necessarily identify all failure points of an encoder.

### SUMMARY OF THE INVENTION

Post multi-modal coding overcomes the shortcomings of video encoders which fail to meet an expected quality standard while encoding some portions of a video. The deficient encoding is typically due to the type of video content or the encoding technique. A method to improve the quality of the deficient portions, identifies macroblocks that are encoded at a deficient quality. Then, the identified macroblocks are encoded with another suitable encoding technique so that the desired quality is met. The improved macroblocks are then inserted into the original bit-stream, replacing the lower quality sections.

In one aspect, a system for enhancing video encoding implemented on a computing device comprises a plurality of encoders for encoding a video using a plurality of encoding schemes, a quality analyzer and classifier for analyzing and classifying video segments of the video and a bit stream manipulator for forming an encoded video by combining the video segments encoded in the plurality of encoding schemes. The plurality of encoders includes a conventional video encoder, a texture encoder and is a structure encoder. Classifying the video segments is by determining if a difference between a distortion generated by the encoded video and an average distortion of the video is below a threshold. Classifying the video segments is by comparing a variance of each of the video segments and an average variance of a frame and Group of Pictures (GOP) video segments. Analyzing and classifying the video segments of the video occurs automatically. The plurality of video encoders, the quality analyzer and classifier and the bit-stream manipulator are implemented in either hardware, software or a combination thereof. The computing device is selected from the group consisting of a personal computer, a laptop computer, a computer workstation, a server, a mainframe computer, a handheld computer, a personal digital assistant, a cellular/mobile telephone, a smart appliance, a gaming console, a digital camera, a digital camcorder, a camera phone, an iPod®, a video player, a DVD writer/player, a television and a home entertainment system.

In another aspect, a system for enhancing video encoding implemented on a computing device comprises a first video encoder for encoding video in a first encoding scheme, a video decoder coupled to the first video encoder for decoding the encoded video, a quality analyzer and classifier coupled to the video decoder, the quality analyzer and classifier for analyzing and classifying video segments of the video, a second video encoder coupled to the quality analyzer and classifier, the second video encoder for encoding first selected video segments in a second encoding scheme, a third video encoder coupled to the quality analyzer and classifier, the third video encoder for encoding second selected video segments in a third encoding scheme and a bit-stream manipulator coupled to the first video encoder, the second video encoder and the third video encoder, the bit-stream manipulator for forming an encoded video by combining the video segments encoded in the first encoding scheme, the first selected video segments encoded in the second encoding scheme and the second selected video segments encoded in the third encoding scheme. The first video encoder is a conventional video encoder, the second video encoder is a texture encoder and the third video encoder is a structure encoder. Classifying the video segments is by determining if a difference between a distortion generated by the encoded video and an average distortion of the video is below a threshold. Classifying the video segments is by comparing a variance of each of the video segments and an average variance of a frame and Group of Pictures (GOP) video segments. Each video segment in this scheme is able to include one or more multiple spatial and/or temporal macroblock. In the simplest case, each video segment includes only one macroblock and therefore the comparison between different coding schemes is performed at the macroblock level, one macroblock at a time. The first selected video segments are stored in a first library and the second selected video segments are stored in a second library. The video segments are able to be selected to be as small as a single macroblock. Analyzing and classifying the video segments of the video occurs automatically. The first video encoder, the video decoder, the quality analyzer and classifier, the second video encoder, the third video encoder and the bit-stream manipulator are implemented in either hardware, software or a combination thereof. The computing device is selected from the group consisting of a personal computer, a laptop computer, a computer workstation, a server, a mainframe computer, a handheld computer, a personal digital assistant, a cellular/mobile telephone, a smart appliance, a gaming console, a digital camera, a digital camcorder, a camera phone, an iPod®, a video player, a DVD writer/player, a television and a home entertainment system.

In another aspect, a method of enhancing video encoding implemented on a computing device comprises encoding a video comprising video segments using a first encoder, decoding the video using a decoder, classifying the video segments as a first quality and a second quality, classifying the video segments of the second quality as a first type and a second type, encoding the video segments of the first type using a second encoder, encoding the video segments of the second type using a third encoder and replacing the video segments of the second quality with the video segments of the first type and the video segments of the second type to form an encoded video. The first quality is high quality and the second quality is low quality. Classifying the video segments as the first quality and the second quality is by determining if a difference between a distortion generated by an encoded video and an average distortion of the video is below a threshold. The first encoder is a conventional video encoder, the second encoder is a texture encoder and the third encoder is a structure encoder. Classifying the video segments of the second quality as the first type and the second type is by comparing a variance of each of the video segments and an average variance of a frame and Group of Pictures (GOP) video segments. The video segments of the first type are stored in a first library and the video segments of the second type are stored in a second library. The video segments are able to be selected to be as small as a single macroblock. Classifying the video segments as the first quality and the second quality and classifying the video segments of the second quality as the first type and the second type occur automatically. The computing device is selected from the group consisting of a personal computer, a laptop computer, a computer workstation, a server, a mainframe computer, a handheld computer, a personal digital assistant, a cellular/mobile telephone, a smart appliance, a gaming console, a digital camera, a digital camcorder, a camera phone, an iPod®, a video player, a DVD writer/player, a television and a home entertainment system.

In another aspect, a device comprises an encoder system which comprises a plurality of encoders for encoding a video using a plurality of encoding schemes, a first decoder decoding the video encoded with an encoding scheme of the encoding schemes, a quality analyzer and classifier for analyzing and classifying video segments of the video and a bit stream manipulator for forming an encoded video by combining the video segments encoded in the plurality of encoding schemes and a decoder system operatively coupled to the encoder system, the decoder system comprises a bit-stream analyzer and splitter for analyzing and splitting the encoded video based on the plurality of encoding schemes, a plurality of second decoders for decoding the video segments of the encoded video based on the plurality of encoding schemes and a scene composer for composing a decoded video from the decoded video segments. The plurality of encoders include a conventional video encoder, a texture encoder and a structure encoder. The plurality of second decoders include a conventional video decoder, a texture decoder and a structure decoder. Classifying the video segments is by determining if a difference between a distortion generated by the encoded video and an average distortion of the video is below a threshold. Classifying the video segments is by comparing a variance of each of the video segments and an average variance of a frame and Group of Pictures (GOP) video segments. The video segments are able to be selected to be as small as a single macroblock. Analyzing and classifying the video segments of the video occurs automatically. The encoder system and the decoder system are implemented in software. The encoder system and the decoder system are implemented in hardware. One of the encoder system and the decoder system is implemented in software and one is implemented in hardware. The device is selected from the group consisting of a camera, camcorder and camera phone.

In another aspect, an application executed on a computing device, the application for enhancing video encoding comprises a first video encoder module for encoding video in a first encoding scheme, a video decoder module operatively coupled to the first video encoder, the video decoder for decoding the encoded video, a quality analyzer and classifier module operatively coupled to the video decoder module, the quality analyzer and classifier module for analyzing and classifying video segments of the video, a second video encoder module operatively coupled to the quality analyzer and classifier module, the second video encoder module for encoding first selected video segments in a second encoding scheme, a third video encoder module operatively coupled to the quality analyzer and classifier module, the third video encoder module for encoding second selected video segments in a third encoding scheme and a bit-stream manipulator module operatively coupled to the first video encoder module, the second video encoder module and the third video encoder module, the bit-stream manipulator module for forming an encoded video by combining the video segments encoded in the first encoding scheme, the first selected video segments encoded in the second encoding scheme and the second selected video segments encoded in the third encoding scheme. The first video encoder module is a conventional video encoder, the second video encoder module is a texture encoder and the third video encoder module is a structure encoder. Classifying the video segments is by determining if a difference between a distortion generated by the encoded video and an average distortion of the video is below a threshold. Classifying the video segments is by comparing a variance of each of the video segments and an average variance of a frame and Group of Pictures (GOP) video segments. The first selected video segments are stored in a first library and the second selected video segments are stored in a second library. The video segments are able to be selected to be as small as a single macroblock. Analyzing and classifying the video segments of the video occurs automatically. The computing device is selected from the group consisting of a personal computer, a laptop computer, a computer workstation, a server, a mainframe computer, a handheld computer, a personal digital assistant, a cellular/mobile telephone, a smart appliance, a gaming console, a digital camera, a digital camcorder, a camera phone, an iPod®, a video player, a DVD writer/player, a television and a home entertainment system.

### BRIEF DESCRIPTION OF THE DRAWINGS

FIG. 1 illustrates an enhanced video encoder for enhancing video encoding.

FIG. 2 illustrates a video decoder for decoding the enhanced video.

FIG. 3 illustrates a flowchart of a method of encoding a video.

FIG. 4 illustrates a flowchart of a method of decoding a video.

FIG. 5 illustrates a block diagram of an exemplary computing device.

FIG. 6 illustrates a block diagram of a computing device such as a camcorder implementing the encoder and decoder.

### DETAILED DESCRIPTION OF THE PREFERRED EMBODIMENT

Post multi-modal coding enhances video encoding by finding and identifying regions of the video in which the encoder fails or does not perform with the desired quality. Then, the bit-stream is manipulated on the failed parts, and the corresponding areas are encoded with different means which significantly improves the quality of decoded streams in the areas. Side information (such as characteristics of the area and/or the type of encoding/codec) is sent to assist in classification and formation of the encoded video. When the encoded video is decoded, the quality of decoded video is significantly improved, and depending on the scene and encoding mechanism, the size of the stream is not increased or is only increased marginally.

The quality of an encoder is measured for any given video input by measuring the performance of the encoder on a macroblock level and then automatically identifying the macroblocks that have not been encoded with a desired quality. Then, an alternative method of encoding the macroblocks is automatically used, and the quality of video is improved wherever the video has been failed by the original encoder.

The quality of encoding is measured by encoding the video and comparing the quality of encoding of problematic areas against the quality of encoding areas using alternative methods. After choosing the best method, the original part of the bit stream is replaced with the new sub-stream, which therefore does not add extra undesirable overhead in terms of file size. The classification method of the failed macroblocks is simple by comparing the variance and the means of the failed macroblock to the average variance of the macroblocks at the frame level and at the Group-Of-Picture (GOP) level. The distortion generated by an encoded macroblock is compared to the average distortion of the video, and if the difference is more than a certain threshold, the macroblock is considered as an area in which the original encoder failed to provide the desired quality. Then, the macroblock is classified as a texture or a structural macroblock according to a comparison between its variance and the average variance of the frame and GOP macroblocks. Each texture and structure macroblock needed to be encoded again is put in a separate library. In some embodiments, the conventionally encoded video is also put in a library. A method of encoding each library is employed to re-encode those macroblocks and to change the corresponding part of the original bitstream with the new sub-streams.

Any efficient coding techniques are able to be employed to encode the macroblocks in different libraries. For example, each library is able to be clustered to different subclasses and a seed macroblock is calculated for each subclass. A seed macroblock is equivalent to a reference macroblock in conventional video coding schemes. A seed macro block is coded independently (or as part of a referenced sub-frame) and other macroblocks at different temporal or spatial location are predicted from the seed macroblock using a transformation. The transformation is identified which maps the seed macroblock to each macroblock in that cluster with different parameters. Then, for encoding, the seed macroblocks are able to be encoded as intra macroblocks (if they are not already encoded by the conventional coder in some other part of the GOP) and also the transform parameters for each macroblock of that cluster are encoded and put in the stream.

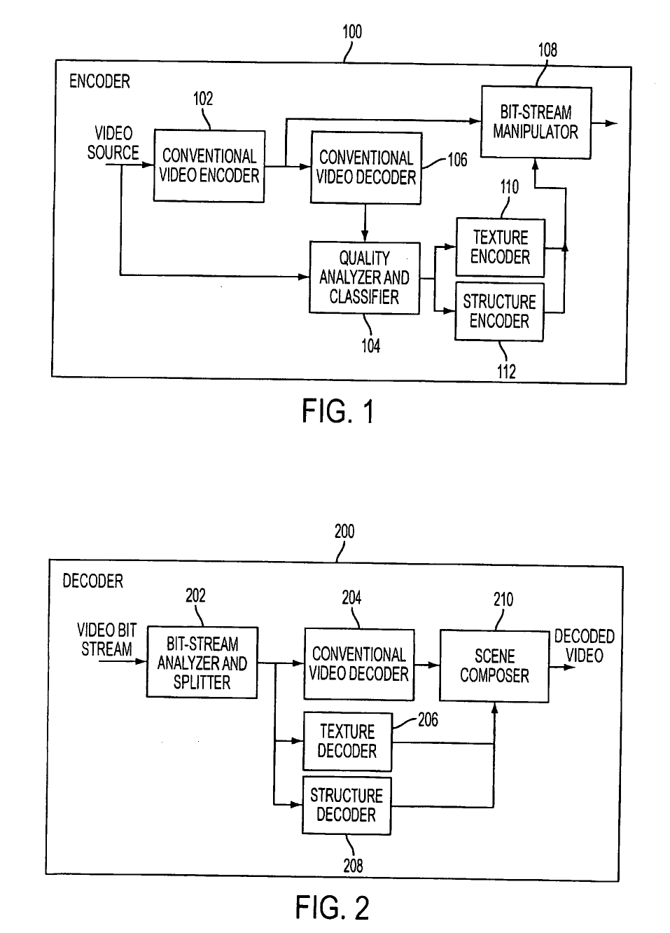

FIG. 1 illustrates an enhanced video encoder 100 for enhancing video encoding. In some embodiments, the enhanced video encoder 100 includes a conventional video encoder 102 coupled to a quality analyzer/classifier 104, a conventional video decoder 106 and a bit-stream manipulator 108. The conventional video decoder 106 is also coupled to the quality analyzer/classifier 104. The quality analyzer/classifier 104 is coupled to a texture encoder 110 and a structure encoder 112. The texture encoder 110 and the structure encoder 112 are coupled to the bit stream manipulator 108.

In operation, a video source is received at the conventional video encoder 102 and the quality analyzer/classifier 104. The conventional video encoder 102 encodes the video source. The encoded video from the conventional video encoder 102 goes to the bit-stream manipulator 108 and the conventional video decoder 106. The encoded video is decoded at the conventional video decoder 106 and is sent to the quality analyzer/classifier 104.

The quality analyzer/classifier 104 analyzes the quality of the video which was encoded and then decoded and classifies the video depending on the quality. More specifically, sections of the video, such as macroblocks, are analyzed and then classified. In some embodiments, the sections of the video are classified as high quality if the video quality meets a certain threshold, and the video is classified as low quality if the video quality does not meet the threshold. To classify a macroblock based on quality, the quality analyzer/classifier 104 compares the distortion generated by an encoded macroblock to the average distortion of the video, and if the difference is more than a threshold, the macroblock is considered as an area in which the conventional video encoder 102 failed to provide the desirable quality. Then, the macroblock of the video is classified as a texture or a structure macroblock according to a comparison between the variance and the average variance of the frame and GOP macroblocks. Each texture and structure macroblock needed to be encoded again is put in a separate library. Each library is encoded to re-encode the low quality macroblocks at the appropriate texture encoder 110 or structure encoder 112. Any efficient coding techniques are able to be employed to encode the macroblocks in different libraries. For example, each library is able to be clustered to different subclasses and a seed macroblock is calculated for each subclass. Also, a transform is identified which maps the seed macroblock to each macroblock in that cluster with different parameters. Then, for encoding, the seed macroblocks are able to be encoded as intra macroblocks (if they are not already encoded by the conventional coder in some other part of the GOP), and also the transform parameters for each macroblock of that cluster are encoded and put in the stream.

The bit-stream manipulator 108 is able to modify the bit-stream by adding improved encoded video such as texture or structure encoded video to the conventionally encoded video. The bit-stream manipulator 108 receives the re-encoded video sections with new sub-streams and replaces the corresponding sections of the original bit-stream with the new sub-streams.

FIG. 2 illustrates a video decoder 200 for decoding the enhanced video. The video decoder 200 includes a bit-stream analyzer and splitter 202. The bit-stream analyzer and splitter 202 is coupled to a conventional video decoder 204, a texture decoder 206 and a structure decoder 208. The video decoder 204, texture decoder 206 and structure decoder 208 are each coupled to a scene composer 210.

In operation, a video bit stream is received at the bit-stream analyzer and splitter 202. The bit-stream analyzer and splitter 202 analyzes the bit-stream and then splits the bit-stream based on the type of encoding used for that bit-stream. The bit-stream is split to go to either the conventional video decoder 204, the texture decoder 206 or the structure decoder 208. Each of the respective decoders (204, 206, 208) decode the received bit-streams or bit-stream sections. The scene composer 210 composes a decoded video from the different decoded bit-stream sections. The decoded video is then able to be viewed on a computing device including, but not limited to, a personal computer, a laptop computer, a computer workstation, a server, a mainframe computer, a handheld computer, a personal digital assistant, a cellular/mobile telephone, a smart appliance, a gaming console, a digital camera, a digital camcorder, a camera phone, an iPod®, a video player, a DVD writer/player, a television or a home entertainment system.

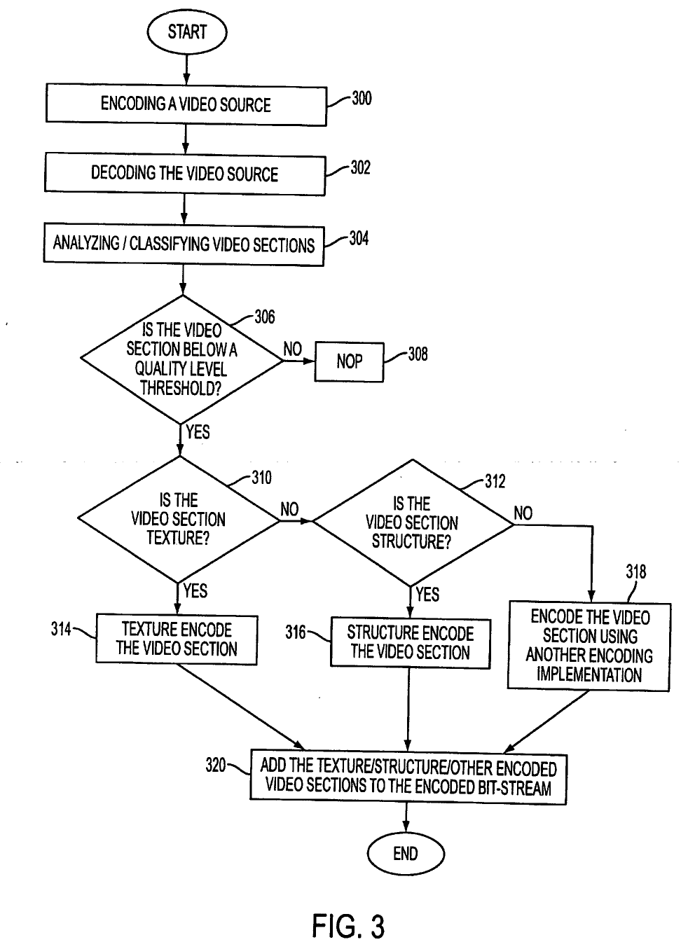

FIG. 3 illustrates a flowchart of a method of encoding a video. In the step 300, a video source is encoded. The encoded video goes to the bit-stream manipulator and the conventional video decoder. In the step 302, the conventional video decoder decodes the video. In the step 304, the video source is analyzed and classified; specifically, sections of the video source are analyzed and classified. In the step 306, it is determined if any of the video sections are below a quality threshold (e.g. poor quality). As described above, to classify sections, such as macroblocks, based on quality, the quality analyzer/classifier compares the distortion generated by an encoded macroblock to the average distortion of the video, and if the difference is more than a threshold, the macroblock is considered as an area in which the conventional video encoder failed to provide the desirable quality. If the section is high quality or above the quality threshold, then no operation is performed on that section in the step 308 because the conventional encoding is sufficient. If the quality is below the threshold in the step 306, then it is determined what type of section the video section is. The section/macroblock of the video is classified as a texture or a structure macroblock according to a comparison between the variance and the average variance of the frame and GOP macroblocks. In the step 310, it is determined if the video section is a texture section. If the video section is a texture section in the step 310, then the section is texture encoded, in the step 314. If the video section is not a texture section in the step 310, it is determined if the video section is a structure section, in the step 312. If the video section is a structure section in the step 312, then the video section is structure encoded, in the step 316. In some embodiments, if the video section is not a structure section in the step 312, then the video section is encoded using another encoding implementation, in the step 318. In some embodiments, the order of determining whether the video section is a texture section, a structure section or another section, is different. For example, in some embodiments, structure sections are determined first and then texture sections are determined. In some embodiments, classifying the sections is performed in parallel. Furthermore, encoding of the sections is able to occur in different orders or in parallel. In the step 320, the encoded sections using texture, structure or another encoding are added to the bit-stream by replacing the same section that had poor quality using the conventional encoding. The encoded video is then able to be decoded and viewed.

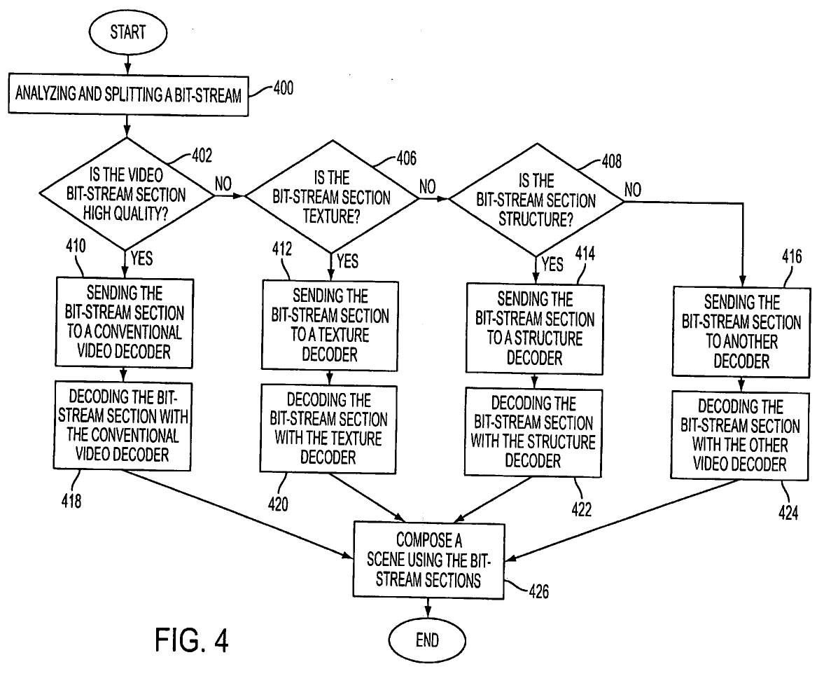

FIG. 4 illustrates a flowchart of a method of decoding a video. In the step 400, the video bit-stream is analyzed and split. The video bit-stream is analyzed to determine if the encoding is conventional encoding, texture encoding, structure encoding or another encoding. The video bit-stream is split based on the encoding type. In some embodiments, the analyzing and splitting are two separate steps. In the step 402, it is determined if the video bit-stream section is high quality which was encoded using the conventional encoder. If the video bit-stream section is high quality, then in the step 410, the bit-stream section is sent to a conventional video decoder. If the video bit-stream section is not high quality, then in the step 406, it is determined if the video bit-stream section is texture encoded. If the video bit-stream section is texture, then in the step 412, the bit-stream section is sent to a texture decoder. If the video bit-stream section is not texture encoded, then in the step 408, it is determined if the video bit-stream section is structure encoded. If the video bit-stream section is structure encoded, then in the step 414, the bit-stream section is sent to a structure decoder. If the video bit-stream section is not structure encoded, then the bit-stream section is sent to another decoder, in the step 416. If the video bit-stream section is sent to the conventional decoder, then the bit-stream section is decoded using the conventional video decoder in the step 418. If the video bit-stream section is sent to the texture decoder, then the bit-stream section is decoded using the texture decoder in the step 420. If the video bit-stream section is sent to the structure decoder, then the bit-stream section is decoded using the structure decoder in the step 422. If the video bit-stream section is sent to another decoder, then the bit-stream section is decoded using the other decoder in the step 424. In some embodiments, the decoding of the video sections occurs in a different order or in parallel. In the step 426, a scene is composed using the decoded bit-stream sections which are pieced together.

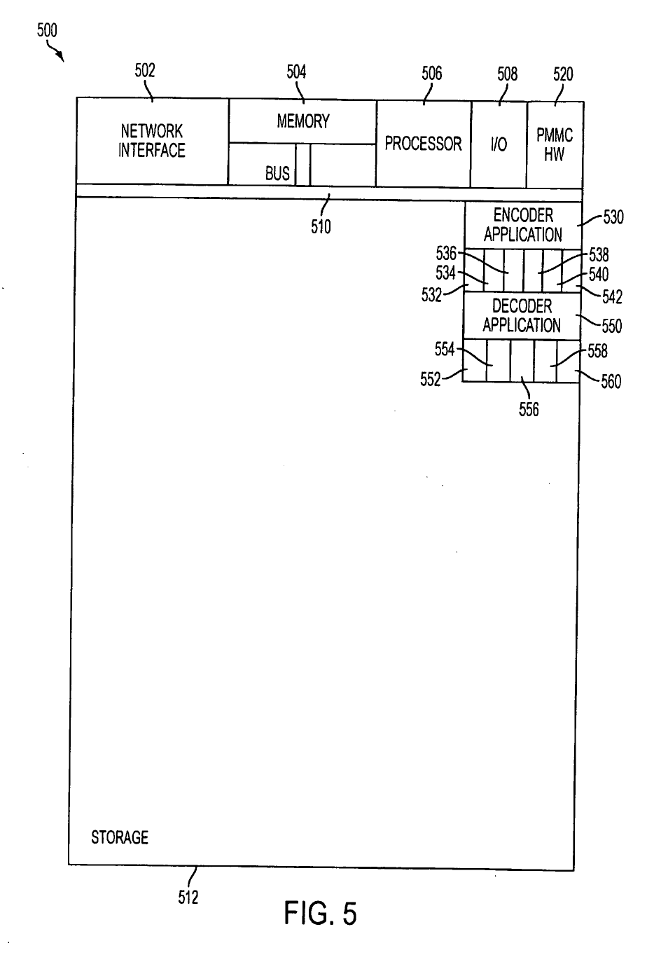

FIG. 5 illustrates a block diagram of an exemplary computing device 500. The computing device 500 is able to be used to acquire, store, compute, communicate and/or display information such as images and videos. For example, a computing device 500 acquires a video, and then the acquired video is encoded using post multi-modal coding. In general, a hardware structure suitable for implementing the computing device 500 includes a network interface 502, a memory 504, a processor 506, I/O device(s) 508, a bus 510 and a storage device 512. The choice of processor is not critical as long as a suitable processor with sufficient speed is chosen. The memory 504 is able to be any conventional computer memory known in the art. The storage device 512 is able to include a hard drive, CDROM, CDRW, DVD, DVDRW, flash memory card or any other storage device. The computing device 500 is able to include one or more network interfaces 502. An example of a network interface includes a network card connected to an Ethernet or other type of LAN. The I/O device(s) 508 are able to include one or more of the following: keyboard, mouse, monitor, display, printer, modem, touchscreen, button interface and other devices. Encoder application(s) 530 used to perform the post multi-modal coding are likely to be stored in the storage device 512 and memory 504 and processed as applications are typically processed. In some embodiments, decoder application(s) 550, decoder firmware and/or decoder hardware are included for decoding. More or less components shown in FIG. 5 are able to be included in the computing device 500. In some embodiments, post multi-modal coding hardware 520 is included. Although, the computing device 500 in FIG. 5 includes applications 530 and hardware 520 for post multi-modal coding, the post multi-modal coding is able to be implemented on a computing device in hardware, firmware, software or any combination thereof.

In some embodiments, the encoder applications 530 include a conventional video encoder module 532, a conventional video decoder module 534, a quality analyzer/classifier module 536, a texture encoder module 538, a structure encoder module 540 and a bit-stream manipulator module 542. In some embodiments, the decoder applications 550 include a bit-stream analyzer/splitter module 552, a conventional video decoder module 554, a texture decoder module 556, a structure decoder module 558 and a scene composer module 560. Each of the modules performs the respective tasks described above.

Examples of suitable computing devices include a personal computer, a laptop computer, a computer workstation, a server, a mainframe computer, a handheld computer, a personal digital assistant, a cellular/mobile telephone, a smart appliance, a gaming console, a digital camera, a digital camcorder, a camera phone, an iPod®, a video player, a DVD writer/player, a television, a home entertainment system or any other suitable computing device.

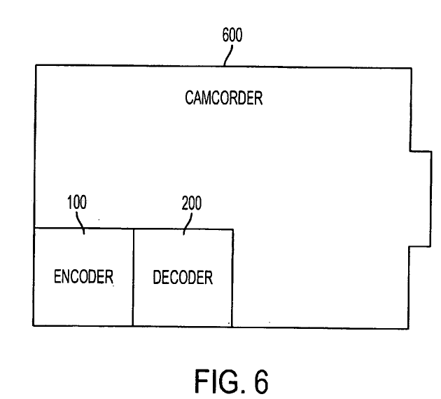

FIG. 6 illustrates a block diagram of a computing device 600 such as a camcorder implementing the encoder 100 and the decoder 200. In some embodiments, the encoder 100 and the decoder 200 are operatively coupled. For brevity, the components of the encoder 100 and the decoder 200 are not described in detail again. An exemplary use of the camcorder includes acquiring a video such as a video of a wedding celebration which is then encoded by the encoder 100. To play back the video on the camcorder, the encoded video is decoded by the decoder 200 and is then presented on the display for viewers to watch the video. As described above, the encoder 100 or components of the encoder 100 are able to be implemented in software, firmware, hardware or any combination thereof. Additionally, the decoder 200 or components of the decoder 200 are able to be implemented in software, firmware, hardware or any combination thereof. Although FIG. 6 illustrates a computing device 600 with both the encoder 100 and the decoder 200, other computing devices are able to have only the encoder 100 or only the decoder 200.

To utilize post multi-modal coding, a computing device operates as usual, but the encoding process is improved in that it is more efficient and more accurate by implementing post multi-modal coding process. The utilization of the computing device from the user's perspective is similar or the same as one that uses standard encoding. For example, the user still simply turns on a digital camcorder and uses the camcorder to record a video. The post multi-modal coding process is able to automatically improve the encoding process without user intervention. The post multi-modal coding process is able to be used anywhere that requires video encoding. Many applications are able to utilize the post multi-modal coding process.

In operation, post multi-modal coding improves the encoding process by providing a better coding scheme if the quality of a video section does not meet a quality threshold. Video that is encoded which meets or exceeds the quality threshold, is encoded using a conventional video encoder, but video that does not meet the quality threshold is encoding using a different encoding type such as texture, structure or another type of encoding. The encoded video sections that are encoded with other types of encoding are added to the video bit-stream and replace the poor quality encoded sections so that the size of the bit-stream is exactly or at least roughly the same. Decoding of the video is performed by splitting the video into the differently encoded sections so that each section is able to be decoded by the appropriate decoder. The separately decoded sections are combined to form the decoded video.

The present invention has been described in terms of specific embodiments incorporating details to facilitate the understanding of principles of construction and operation of the invention. Such reference herein to specific embodiments and details thereof is not intended to limit the scope of the claims appended hereto. It will be readily apparent to one skilled in the art that other various modifications may be made in the embodiment chosen for illustration without departing from the spirit and scope of the invention as defined by the claims.

What is claimed is:

1. A system for enhancing video encoding implemented on a computing device comprising:
a. a plurality of encoders for encoding a video using a plurality of encoding schemes;
b. a quality analyzer and classifier for analyzing and classifying video segments of the video; and
c. a bit stream manipulator for forming an encoded video by combining the video segments encoded in the plurality of encoding schemes.

2. The system of claim 1 wherein the plurality of encoders includes a conventional video encoder, a texture encoder and is a structure encoder.

3. The system of claim 1 wherein classifying the video segments is by determining if a difference between a distortion generated by the encoded video and an average distortion of the video is below a threshold.

4. The system of claim 1 wherein classifying the video segments is by comparing a variance of each of the video segments and an average variance of a frame and Group of Pictures (GOP) video segments.

5. The system of claim 1 wherein the video segments include at least a single macroblock.

6. The system of claim 1 wherein analyzing and classifying the video segments of the video occurs automatically.

7. The system of claim 1 wherein the plurality of video encoders, the quality analyzer and classifier and the bit-stream manipulator are implemented in software.

8. The system of claim 1 wherein the plurality of video encoders, the quality analyzer and classifier and the bit-stream manipulator are implemented in hardware.

9. The system of claim 1 wherein at least one of the plurality of video encoders, the quality analyzer and classifier and the bit-stream manipulator is implemented in software and at least one is implemented in hardware.

10. The system of claim 1 wherein the computing device is selected from the group consisting of a personal computer, a laptop computer, a computer workstation, a server, a mainframe computer, a handheld computer, a personal digital assistant, a cellular/mobile telephone, a smart appliance, a gaming console, a digital camera, a digital camcorder, a camera phone, an iPod®, a video player, a DVD writer/player, a television and a home entertainment system.

11. A system for enhancing video encoding implemented on a computing device comprising:
a. a first video encoder for encoding video in a first encoding scheme;
b. a video decoder coupled to the first video encoder for decoding the encoded video;
c. a quality analyzer and classifier coupled to the video decoder, the quality analyzer and classifier for analyzing and classifying video segments of the video;
d. a second video encoder coupled to the quality analyzer and classifier, the second video encoder for encoding first selected video segments in a second encoding scheme;
e. a third video encoder coupled to the quality analyzer and classifier, the third video encoder for encoding second selected video segments in a third encoding scheme; and
f. a bit-stream manipulator coupled to the first video encoder, the second video encoder and the third video encoder, the bit-stream manipulator for forming an encoded video by combining the video segments encoded in the first encoding scheme, the first selected video segments encoded in the second encoding scheme and the second selected video segments encoded in the third encoding scheme.

12. The system of claim 11 wherein the first video encoder is a conventional video encoder, the second video encoder is a texture encoder and the third video encoder is a structure encoder.

13. The system of claim 11 wherein classifying the video segments is by determining if a difference between a distortion generated by the encoded video and an average distortion of the video is below a threshold.

14. The system of claim 11 wherein classifying the video segments is by comparing a variance of each of the video segments and an average variance of a frame and Group of Pictures (GOP) video segments.

15. The system of claim 11 wherein the first selected video segments are stored in a first library and the second selected video segments are stored in a second library.

16. The system of claim 11 wherein the video segments video segments include at least a single macroblock.

17. The system of claim 11 wherein analyzing and classifying the video segments of the video occurs automatically.

18. The system of claim 11 wherein the first video encoder, the video decoder, the quality analyzer and classifier, the second video encoder, the third video encoder and the bit-stream manipulator are implemented in software.

19. The system of claim 11 wherein the first video encoder, the video decoder, the quality analyzer and classifier, the second video encoder, the third video encoder and the bit-stream manipulator are implemented in hardware.

20. The system of claim 11 wherein at least one of the first video encoder, the video decoder, the quality analyzer and classifier, the second video encoder, the third video encoder and the bit-stream manipulator is implemented in software and at least one is implemented in hardware.

21. The system of claim 11 wherein the computing device is selected from the group consisting of a personal computer, a laptop computer, a computer workstation, a server, a mainframe computer, a handheld computer, a personal digital assistant, a cellular/mobile telephone, a smart appliance, a gaming console, a digital camera, a digital camcorder, a camera phone, an iPod®, a video player, a DVD writer/player, a television and a home entertainment system.

22. A method of enhancing video encoding implemented on a computing device comprising:
a. encoding a video comprising video segments using a first encoder;
b. decoding the video using a decoder;
c. classifying the video segments as a first quality and a second quality;
d. classifying the video segments of the second quality as a first type and a second type;
e. encoding the video segments of the first type using a second encoder;
f. encoding the video segments of the second type using a third encoder; and
g. replacing the video segments of the second quality with the video segments of the first type and the video segments of the second type to form an encoded video.

23. The method of claim 22 wherein the first quality is high quality and the second quality is low quality.

24. The method of claim 22 wherein classifying the video segments as the first quality and the second quality is by determining if a difference between a distortion generated by an encoded video and an average distortion of the video is below a threshold.

25. The method of claim 22 wherein the first encoder is a conventional video encoder, the second encoder is a texture encoder and the third encoder is a structure encoder.

26. The method of claim 22 wherein classifying the video segments of the second quality as the first type and the second type is by comparing a variance of each of the video segments and an average variance of a frame and Group of Pictures (GOP) video segments.

27. The method of claim 22 wherein the video segments of the first type are stored in a first library and the video segments of the second type are stored in a second library.

28. The method of claim 22 wherein the video segments video segments include at least a single macroblock.

29. The method of claim 22 wherein classifying the video segments as the first quality and the second quality and classifying the video segments of the second quality as the first type and the second type occur automatically.

30. The method of claim 22 wherein the computing device is selected from the group consisting of a personal computer, a laptop computer, a computer workstation, a server, a mainframe computer, a handheld computer, a personal digital assistant, a cellular/mobile telephone, a smart appliance, a gaming console, a digital camera, a digital camcorder, a camera phone, an iPod®, a video player, a DVD writer/player, a television and a home entertainment system.

31. A device comprising:
a. an encoder system comprising:
i. a plurality of encoders for encoding a video using a plurality of encoding schemes;
ii. a first decoder decoding the video encoded with an encoding scheme of the encoding schemes;
iii. a quality analyzer and classifier for analyzing and classifying video segments of the video; and
iv. a bit stream manipulator for forming an encoded video by combining the video segments encoded in the plurality of encoding schemes; and
b. a decoder system operatively coupled to the encoder system, the decoder system comprising:
i. a bit-stream analyzer and splitter for analyzing and splitting the encoded video based on the plurality of encoding schemes;
ii. a plurality of second decoders for decoding the video segments of the encoded video based on the plurality of encoding schemes; and
iii. a scene composer for composing a decoded video from the decoded video segments.

32. The device of claim 31 wherein the plurality of encoders include a conventional video encoder, a texture encoder and a structure encoder.

33. The device of claim 31 wherein the plurality of second decoders include a conventional video decoder, a texture decoder and a structure decoder.

34. The device of claim 31 wherein classifying the video segments is by determining if a difference between a distortion generated by the encoded video and an average distortion of the video is below a threshold.

35. The device of claim 31 wherein classifying the video segments is by comparing a variance of each of the video segments and an average variance of a frame and Group of Pictures (GOP) video segments.

36. The device of claim 31 wherein the video segments video segments include at least a single macroblock.

37. The device of claim 31 wherein analyzing and classifying the video segments of the video occurs automatically.

38. The device of claim 31 wherein the encoder system and the decoder system are implemented in software.

39. The device of claim 31 wherein the encoder system and the decoder system are implemented in hardware.

40. The device of claim 31 wherein one of the encoder system and the decoder system is implemented in software and one is implemented in hardware.

41. The device of claim 31 wherein the device is selected from the group consisting of a camera, camcorder and camera phone.

42. An application executed on a computing device, the application for enhancing video encoding comprising:
a. a first video encoder module for encoding video in a first encoding scheme;
b. a video decoder module operatively coupled to the first video encoder, the video decoder for decoding the encoded video;
c. a quality analyzer and classifier module operatively coupled to the video decoder module, the quality analyzer and classifier module for analyzing and classifying video segments of the video;
d. a second video encoder module operatively coupled to the quality analyzer and classifier module, the second video encoder module for encoding first selected video segments in a second encoding scheme;
e. a third video encoder module operatively coupled to the quality analyzer and classifier module, the third video encoder module for encoding second selected video segments in a third encoding scheme; and
f. a bit-stream manipulator module operatively coupled to the first video encoder module, the second video encoder module and the third video encoder module, the bit-stream manipulator module for forming an encoded video by combining the video segments encoded in the first encoding scheme, the first selected video segments encoded in the second encoding scheme and the second selected video segments encoded in the third encoding scheme.

43. The application of claim 42 wherein the first video encoder module is a conventional video encoder, the second video encoder module is a texture encoder and the third video encoder module is a structure encoder.

44. The application of claim 42 wherein classifying the video segments is by determining if a difference between a distortion generated by the encoded video and an average distortion of the video is below a threshold.

45. The application of claim 42 wherein classifying the video segments is by comparing a variance of each of the video segments and an average variance of a frame and Group of Pictures (GOP) video segments.

46. The application of claim 42 wherein the first selected video segments are stored in a first library and the second selected video segments are stored in a second library.

47. The application of claim 42 wherein the video segments video segments include at least a single macroblock.

48. The application of claim 42 wherein analyzing and classifying the video segments of the video occurs automatically.

49. The application of claim 42 wherein the computing device is selected from the group consisting of a personal computer, a laptop computer, a computer workstation, a server, a mainframe computer, a handheld computer, a personal digital assistant, a cellular/mobile telephone, a smart appliance, a gaming console, a digital camera, a digital camcorder, a camera phone, an iPod®, a video player, a DVD writer/player, a television and a home entertainment system.
